(19) United States
(12) Patent Application Publication
(10) Pub. No.: US 2016/0210355 A1
(43) Pub. Date: Jul. 21, 2016

(54) SEARCHING AND CLASSIFYING UNSTRUCTURED DOCUMENTS BASED ON VISUAL NAVIGATION

(71) Applicant: Mindseye Solutions, LLC, Arlington, VA (US)

(72) Inventors: Robert L. Krantz, III, Washington, DC (US); Elliot Paul Nierman, Woodford, VA (US); David Cameron Shedd, Alexandria, VA (US)

(21) Appl. No.: 14/795,324

(22) Filed: Jul. 9, 2015

Related U.S. Application Data
(60) Provisional application No. 62/105,571, filed on Jan. 20, 2015.

(51) Int. Cl. G06F 17/30; G06F 3/0484

(52) U.S. Cl. CPC G06F 17/30699; G06F 17/30719; G06F 17/30011; G06F 3/0484

(57) ABSTRACT

Exemplary embodiments of the invention can provide computer-based systems and methods for exploring collections of documents through visual navigation. Data in a document collection can be more easily understood and explored when presented visually in infographic summaries. By interacting directly with these infographic summaries, a user can more intuitively sift through a collection to organize and locate documents based their properties, metadata, and textual information. Infographic summaries can be updated dynamically as a user selects infographic elements that automatically create document filters and redefine the current scope of displayed documents. User interactions with infographic summaries can be saved and run automatically against newly added documents, thereby classifying new documents without the need of further user interactions.

### CROSS-REFERENCE TO RELATED APPLICATIONS

This application claims priority under 35 U.S.C. §119(e) to U.S. Provisional Patent Application No. 62/105,571, entitled “Method and Apparatus for Searching and Classifying Unstructured Documents Based on Visual Navigation,” filed Jan. 20, 2015.

### FIELD OF THE INVENTION

Embodiments of the present invention relate generally to the fields of information analysis and document navigation. More specifically, embodiments of the present invention describe dynamic user interface techniques to visually navigate, filter, search, identify, analyze, and classify unstructured documents in a large data repository.

### BACKGROUND

Electronic discovery, commonly referred to as e-discovery, refers to any process in which electronically stored information (“ESI”) is sought, located, secured, and/or searched with the intent of using it as evidence in a legal proceeding, an audit, a securities investigation, a forensics investigation or the like. Due to the fact that ESI is normally stored as unstructured data, the process of searching for relevant and responsive documents during an e-discovery effort can be difficult and time consuming. Such search efforts are made even more challenging when court rules require parties to discover and exchange “all responsive documents.”

The term “unstructured data” refers to information or content that either does not have, or does not lend itself to, a pre-defined data model or is not otherwise organized in a pre-defined manner. Unstructured data is usually text-heavy, which can account for its lack of structure. While unstructured data may contain some formatted (and therefore partially structured) information—such as dates, numbers, formatting codes, and certain kinds of tagged statements—the inclusion of such structured information can be sparse compared to fully structured data, which can be stored as fields in databases or can be annotated (e.g., semantically tagged) within fully structured documents. The range of unstructured information, combined with the inconsistencies typical of partially structured documents, can result in irregularities and ambiguities that make it difficult to manipulate, search and review unstructured data using traditional computer programs.

Examples of unstructured data may include electronic books, journals, documents, health records, audio, video, analog data, images, files, and unstructured text such as the body of an e-mail message, a web page, or a word processor document. While the content of unstructured data may not have a defined structure, it will generally come packaged in objects (e.g. in files or documents) that may have their own internal structure (including metadata) and thus can reflect a mix of structured and unstructured data. Collectively, however, such objects are still referred to herein as unstructured data. As another example, a web page created with HyperText Markup Language (“HTML”) can be tagged, and therefore somewhat structured. However, because HTML usually serves rendering processes, not search processes, HTML tags do not typically capture the semantic meaning or function of tagged elements in ways that support automated search-like processing of the information content of a web page. Further, although Extensible HyperText Markup Language (“XHTML”) tagging can allow machine processing of tagged elements, it typically does not capture or convey the semantic meaning of tagged terms necessary for easy and efficient searching.

Because unstructured data commonly occurs in electronic documents, the use of a content or document management system that can categorize information across documents is often preferred over data search and manipulation techniques that are applied within each document. As such, Document management systems traditionally provide special search modules to identify and extract information from collections of unstructured documents that reside in unstructured data repositories. An example of an unstructured data search module is a typical Internet search engine. Search engines have become popular tools for indexing and searching through unstructured data, especially text.

Other commercial solutions can search and analyze collections of unstructured data, but searching still remains challenging due to the existence of natural language text, private codes, cultural differences in vocabulary, the use of different words to convey similar semantic meaning, and spelling mistakes. E-discovery tools typically provide an ability to filter or cull unstructured data using search techniques, so as to reduce the volume of data to only that which is relevant to the request; typically, this is accomplished by determining a specific date range for the request, providing keywords relevant to the request, and the like. However, certain search and retrieval techniques—such as keyword searches, Boolean searches, and even fuzzy searches—have proven to be less than ideal for e-discovery purposes, particularly for determining the relevance of any matching documents, due in part to the vague and imprecise (for searching) nature of ESI itself. For example, information available during search query preparation is often inadequate (e.g., unknown custodians, vague keywords, imprecise phrases, unknown code words, synonyms, etc.), which can make the task of creating a sufficiently inclusive search query difficult.

Additionally, traditional search queries may result in a large number of false positives and/or false negatives. False positives refer to irrelevant material that is nonetheless returned as a result of a search query. False positives result in a high cost of recall and review of the returned material to filter them out. False negatives refer to relevant material that is not returned as a result of a search query designed to retrieve such material. False negatives result in responsive and relevant documents not being collected and/or reviewed. False negatives also cause more time to be consumed in the e-discovery process to search for and uncover responsive information. A high incidence of false positives and false negatives can make it difficult for litigation parties to demonstrate a reasonableness of e-discovery efforts. These difficulties can expose parties to varying levels of legal consequences.

Faceted navigation, also called faceted searching or faceted browsing, is another technique for identifying relevant information in unstructured documents. In faceted navigation, users can explore a collection of unstructured data by applying a filter corresponding to one or more facets, where a facet is a property of an information element within the data. Metadata are examples of facets; metadata are literally data about data. In the context of ESI, metadata generally provides context. It refers to descriptive information about one or more aspects of the underlying data. Metadata can include, for example, the creator or author of the data, the time and date of creation, the means of creation, the location of creation, and the like.

Facets may also be derived from analysis of underlying text or other data, using entity extraction techniques, or derived from pre-existing fields of a document, such as author, descriptor, language, and format. Using faceted navigation, collections of unstructured data can be classified, accessed, and/or ordered based on dynamically selected classifications of facets rather than arranged in a traditional, single, predetermined, taxonomic order. Faceted search has become a popular technique in commercial search applications, particularly those used by online retailers and libraries. In the field of ESI, faceted navigation has also been used to create displays known as “dashboards,” which present fixed views of certain facets of unstructured data. Such dashboards are useful, but they are static, in that they present a preprogrammed, single perspective view of the unstructured data (even though the dashboard displays may be animated). They do not provide a dynamic capability for user-driven, iterative, nested interactions with a document collection.

For at least these reasons, current methods for searching and classifying unstructured data can be challenging for end users who wish to quickly locate and identify sets of documents that match the desired criteria. Even the most helpful, current technologies provide less than adequate solutions for easily searching and sorting unstructured data. And this does not even begin to touch on additional issues that can arise, and existing problems that can become magnified, when new documents are added to an existing document collection after some initial search and/or filtering efforts have already been undertaken. In this situation, previous searches and filters may be rendered moot or they may have to be repeated; new documents may have to be subjected to the same analyses that were undertaken with previous documents; and previously identified documents may have to be filtered, searched, and analyzed again, to ensure they are properly classified and associated with newly added documents. Accordingly, there exists a need in the art for a method and apparatus for processing unstructured data for electronic discovery that overcomes the aforementioned deficiencies.

### SUMMARY

The following summary is provided to introduce, in a simplified form, certain concepts of one or more embodiments of the invention as a prelude to a more detailed description. This summary is not intended to identify key features or essential features of the claimed subject matter, nor is it intended to delineate or limit in any way the scope of the claimed invention.

To address the needs and shortcomings of the technologies and solutions mentioned above, the inventors devised, among other things, systems and methods that enable a user to rapidly explore large collections of unstructured documents using an interactive visual navigation interface. The interactive visual navigation and exploration interface supports an underlying document navigation process that is dynamic, iterative, and cumulative. Embodiments of the invention also combine the various retrieval means detailed above—including: facets, search concepts, metadata, etc.—to provide a unified view of selectable data items on a single, integrated, user interface.

The document navigation and exploration process of the embodiments is dynamic because, at each step, the visual presentation delivered to the user is based on a then-active set of documents. The process is iterative because it can repeat, over and over, as the user navigates deeper into the remaining documents. The process is cumulative, because new navigation choices made by a user can build upon earlier navigation choices to further expand or narrow the scope of documents available for additional exploration and/or searching.

Initially, embodiments of the invention can provide a visual navigation interface to display a set of infographic summaries corresponding to a default collection of documents. In the usual case, the default collection of documents will comprise all documents contained in a given database. However, the default collection can be defined by a user according to any number of methods known in the art of document management. Embodiments of the invention can iteratively (1) analyze a collection of documents for attributes, metadata, and embedded information; (2) perform statistical calculations on the data; and (3) display data and statistical calculations as interactive infographic summaries to facilitate user-driven filtering and navigation. The infographic summaries can comprise a variety of visual depictions of the underlying data and statistical calculations, including bar graphs, pie charts, line graphs, numbers, letters, words, any other two- or three-dimensional representations, or any combination thereof. Infographic summaries can improve a user's ability to understand the scope and content of selected subsets of unstructured documents by taking advantage of the ability of the human visual system to see patterns and trends in graphs, rather than trying to find those patterns and trends in long lists of characters and numbers. In other words, infographic summaries provide a way to identify meaningful content; they graphically present information about a variety of subjects, such as the authors of the content, how the authors communicate, what they're communicating about, and the frequency and the timing of their communications.

At any point in the document navigation and exploration process, embodiments of the invention can allow a user to add filters to alter the scope of documents currently being displayed and analyzed. In the context of the invention, a “filter” is a set of criteria—such as a search term and/or component of an infographic summary (such as a specific metadata value)—which, when applied to a set of documents, can alter the scope of documents under review by including or excluding individual documents from the returned results. In the simple case, if a document matches a filter, the document remains in the current set of documents. If a document does not match a filter, the document is culled out and is no longer available. In accordance with the invention, each filter operation is constructed dynamically as a user (a) selects visual components from displayed infographic summaries, and/or (b) defines new search criteria based on keywords and/or other traditional search parameters.

Embodiments of the invention can allow a user to define a filter by interacting with a component of a displayed infographic summary (such as a row of a histogram or a section of a pie chart). For example, when a user selects a specific component of an infographic summary (for example, clicking on a row of a histogram via a mouse click or other user selection method known in the art), embodiments of the invention can create appropriate database queries and tables to dynamically perform the desired filter operation to limit the scope of documents to those corresponding to a selected component of an infographic. As the scope (e.g., the number) of documents changes as a result of filtering, the infographic summaries can be repeatedly updated to display information associated with the current scope of documents. Subsequent interactions with updated components of infographic summaries can add additional filters to further alter the scope of documents and similarly update the infographic summaries. Using embodiments of the invention to select infographic components in an iterative fashion, a user can “zoom-in” or “drill down” through vast numbers of unstructured documents to locate and identify those particular documents that are relevant to a given interest.

Embodiments of the invention can allow a user to associate documents and classifications with a variety of labels. Such labels can be user-defined or chosen from a predetermined list, such as “sensitive,” “important,” or “not relevant.” Once applied, a label can be used as a filter to redefine the scope of documents and update the infographic summaries.

Embodiments of the invention can also allow a user to create a “concept” filter based on similarities shared among documents. A concept filter can include keyword searches that, for example, locate variants of keywords, introduce wildcard characters, or search for keyword phrases that exclude some nonessential terms or allow greater spacing between essential terms. Concept filters can also be used to redefine the scope of documents and update the infographic summaries.

Embodiments of the invention can record each filter step and display a current set of filters in the order they were selected, as a visual “breadcrumb trail.” Some embodiments can provide a user interface that allows a user to add multiple items to a breadcrumb trail (using a logical “OR” operation) in order to expand a scope of documents, and to combine steps within an exiting breadcrumb trail (using a logical “AND” operation) in order to reduce the scope of documents. Additionally, some embodiments of the invention allow a user to interact directly with the breadcrumb trail to redefine the scope of documents and update the infographic summaries. For example, a user can click on a filter within a breadcrumb trail to remove all subsequent filters that were applied after the chosen filter and, thereby, return to a previously determined scope of documents. Other embodiments allow a user to delete intermediate filters from a breadcrumb trail to remove those filters from the set and subsequently broaden the scope of documents being analyzed. Still other embodiments allow a user to edit an individual filter within the breadcrumb trail.

Once a desired set of documents is defined, some embodiments can provide a user interface that allows a user to save a set of breadcrumb steps as a saved filter. The saved filter can then be applied as a classification rule for future documents that are added to the existing database. In other words, new documents can be loaded into a document database through a process that automatically runs the documents through the saved filters and routes them to the appropriate classifications. In the context of the invention, a “classification” is therefore a saved filter or a set of saved filters.

Embodiments of the invention present visual representations of attributes, metadata, and embedded information of documents, and, thus, help a user to discover a visual story about various subsets of documents in a given document collection. The visual story can help a user to understand the scope, volume, and content of remaining documents and to better identify documents believed to be most relevant and/or most important to a given litigation or other similar endeavor. Ultimately, embodiments of the invention allow a user to explore a document collection by locating, classifying, viewing, and commenting on individual documents through interactions with infographic summaries and selection tools.

### BRIEF DESCRIPTION OF THE DRAWINGS

So that the manner in which the above recited features of the invention can be understood in detail, a more particular description of the invention, summarized above, may be had by reference to embodiments, some of which are illustrated in the appended drawings. Note, however, that the appended drawings illustrate only typical embodiments of this invention and should not, therefore, limit the scope of the invention, for the invention may admit to other equally effective embodiments.

FIG. 1 is a block diagram depicting an exemplary embodiment of a system architecture in accordance with one or more aspects of the invention.

FIG. 2 is a flow diagram depicting an exemplary embodiment of the loading and processing of documents in accordance with one or more aspects of the invention.

FIG. 3 is an exemplary view of a User Interface 300 for at least one embodiment of the invention.

FIG. 4 is an exemplary view of a User Interface 300 illustrating the selection of a first infographic component.

FIG. 5 is an exemplary view of User Interface 300, illustrating the result of a user selecting infographic component 410 (“volatility”) in FIG. 4.

FIG. 6 is an exemplary view of User Interface 300, illustrating the result of a user selecting infographic component 520 (“Lavorato”) in FIG. 5.

FIG. 7 is an exemplary view of User Interface 300, illustrating the result of a user selecting infographic component 620 (“year 2001”) in FIG. 6.

FIG. 8 is an exemplary view of User Interface 300, illustrating the result of a user deletion of a component of filter breadcrumb 710.

FIG. 9 is a flow diagram depicting an exemplary embodiment of a method for filtering a document collection in an iterative fashion in accordance with one or more aspects of the invention.

FIG. 10 is a block diagram of an exemplary embodiment of a Computing Device 1000 in accordance with the present invention.

### DETAILED DESCRIPTION OF THE EMBODIMENTS

### Introduction

Embodiments of the invention now may be described more fully hereinafter with reference to the accompanying drawings, wherein like parts are designated by like reference numerals throughout, and wherein the leftmost digit of each reference number refers to the drawing number of the figure in which the referenced part first appears. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Embodiments of the present invention may employ visual navigation techniques to reduce the complexity of the task of extracting meaning from data—especially large volumes of unstructured data. By pairing visual navigation with dynamic, rule-based, classification techniques, data exploration can be intuitive, efficient, and highly interactive. Certain aspects of visual navigation can utilize infographic summaries associated with or retrieved from the unstructured data. A user can interact with the infographic summaries to conduct a focused analysis on a target data set by building dynamic classifications using filters and faceted search techniques. Dynamic classifications can be based on data attributes, such as metadata and embedded textual information, and can be automated prior to user interaction. A user can also interact with the infographic summaries to dynamically filter the associated data and uncover themes not readily apparent from the raw data. Filtering steps can be saved as rule-based classifications with which future data loaded into an embodiment of the invention can be automatically classified.

### System Architecture

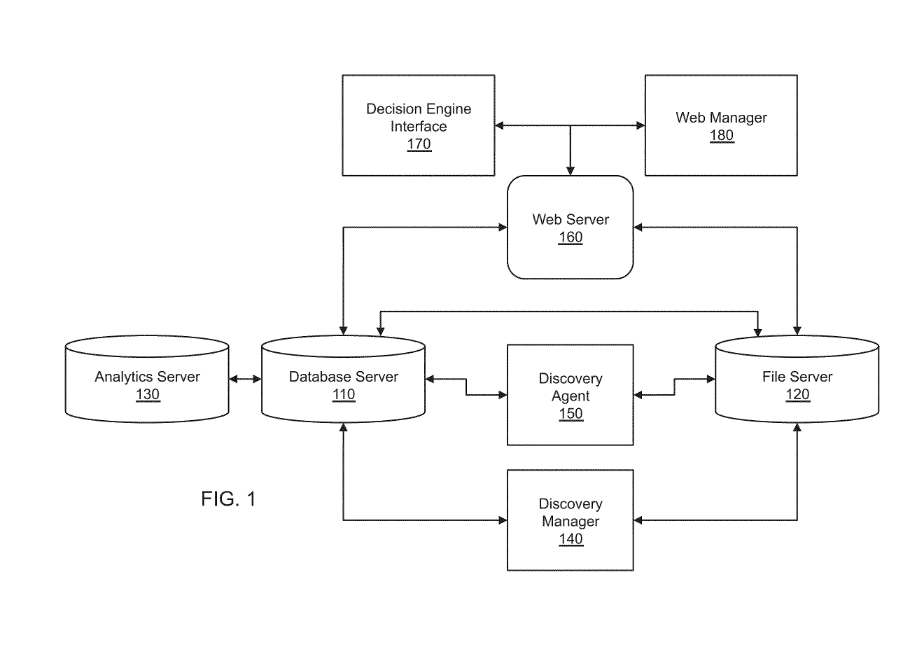

FIG. 1 is a block diagram depicting an exemplary embodiment of a system architecture in accordance with one or more aspects of the invention. In FIG. 1, embodiments of the invention can comprise a Database Server 110, a File Server 120, an Analytics Server 130, a Discovery Manager 140, a Discovery Agent 150, a Web Server 160, a Decision Engine Interface 170, and a Web Manager 180.

The functions provided by Database Server 110, File Server 120, Analytics Server 130, and Web Server 160 can be performed by a single computing device or any combination of computing devices. The depiction in FIG. 1 of these servers as separate entities is intended to illustrate their functional differences and does not indicate that they must correspond to individual physical devices.

Each of the items, modules, and/or servers illustrated in FIG. 1 can communicate with other items by any number of methods known in the art, including inter-process communications protocols and network protocols via networks such as the Internet.

Embodiments of the invention allow unstructured documents to be added to a database residing on Database Server 110 to create a collection (e.g., a database) of unstructured documents suitable for navigation and exploration. Unstructured documents can be loaded directly onto Database Server 110 through any physical means, including: CD-ROMs, DVD-ROMs, Blu-Ray discs, flash drives, hard disk drives, or any other means known to a person skilled in the art. Embodiments of the invention can also allow documents to be loaded remotely from a Discovery Manager 140 or a Discovery Agent 150 via protocols such as FTP, HTTP, E-mail, a web interface, or any other means known to a person skilled in the art.

An unstructured document, in the context of this invention, is a discrete information unit that can comprise one or more types of unstructured data, including: text, formatted text, HTML, spreadsheets, tables, and images. Embodiments of the invention can operate on a variety of common unstructured document types—such as word processing files, spreadsheets, text documents, web pages, images, and e-mails—as well as on undefined file types that may or may not contain textual information.

Unique identifiers can be created for each document in the collection and stored as data points in the database. A data point is any discrete piece of information stored in the database, regardless of whether it originated from a document, a user, or an automated process. Information retrieved from the documents can be saved as data points in the database. Facets, attributes, metadata, and textual content, for example, can be retrieved from documents and saved as data points in the database.

Embodiments of the invention can create data points based on information readily available in the documents, including: document attributes and metadata, language(s) used, file size, file type, author(s), file location, file name, e-mail author, e-mail recipient, e-mail domains of authors and recipients, e-mail action (sent, replied, replied all, forwarded, received, etc.), dates (added, created, modified, sent, received, etc.), e-mail subjects, and e-mail conversation threads. Data points can also be created from content information, such as full text, keywords, keyword phrases, hidden content, and extracted concepts.

Even non-textual documents can be processed in a variety of ways to create data points in the database. For example, one embodiment of the invention can process images using optical character recognition (OCR) to recognize text in the image and/or process images to generate histographic data, which can then be stored as data points in the database.

Embodiments of the invention can also statistically analyze document attributes, metadata, and textual content to create statistical data points. Statistical information can include, for example, data size, number of files, date ranges, duplicate status, custodians, frequencies of attributes, frequencies of textual information, and other statistical information known in the art.

Embodiments of the invention can also create associations between and among data points, or between data points and individual documents, using the documents' unique identifiers.

Referring again to FIG. 1, Database Server 110 corresponds to a database process that can store and provide access to all extracted data points, features, metadata, work product, and user applied structure relating to and/or associated with documents ingested into embodiments of the present invention. Database Server 110 may receive new documents and may initiate loading and normalization processes necessary to ingest the documents into a database management system.

File Server 120 corresponds to another database process that can store and provide access to all native documents themselves; any filtered text, OCR generated text, and images extracted from documents ingested into embodiments of the present invention; and a file system-based full text index of the ingested documents.

Analytics Server 130 corresponds to a processing module that communicates with Database Server 110 to perform analytics-related document processing tasks, such as conceptual indexing, concept and feature extraction, email threading, document clustering, and textual near-duplicate identification.

Discovery Manager 140 corresponds to at least one processing module that can perform tasks relating to initial loading and/or ingestion of documents into embodiments of the invention.

Discovery Agent 150 corresponds to at least one processing module that can perform distributed processing of data, such as rendering images, recognizing text within document images, and indexing the text portions of documents for searching.

Web Server 160 corresponds to a processing module that can generate a web page interface for Decision Engine Interface 170, through which a user can access embodiments of the present invention.

Web Manager 180 corresponds to a processing module that can perform various web maintenance functions for embodiments of the present invention.

Finally, Decision Engine Interface 170 corresponds to a web-based interface through which a user can access embodiments of the present invention to rapidly explore large collections of unstructured documents using an interactive visual navigation interface.

### Loading Documents into the Database

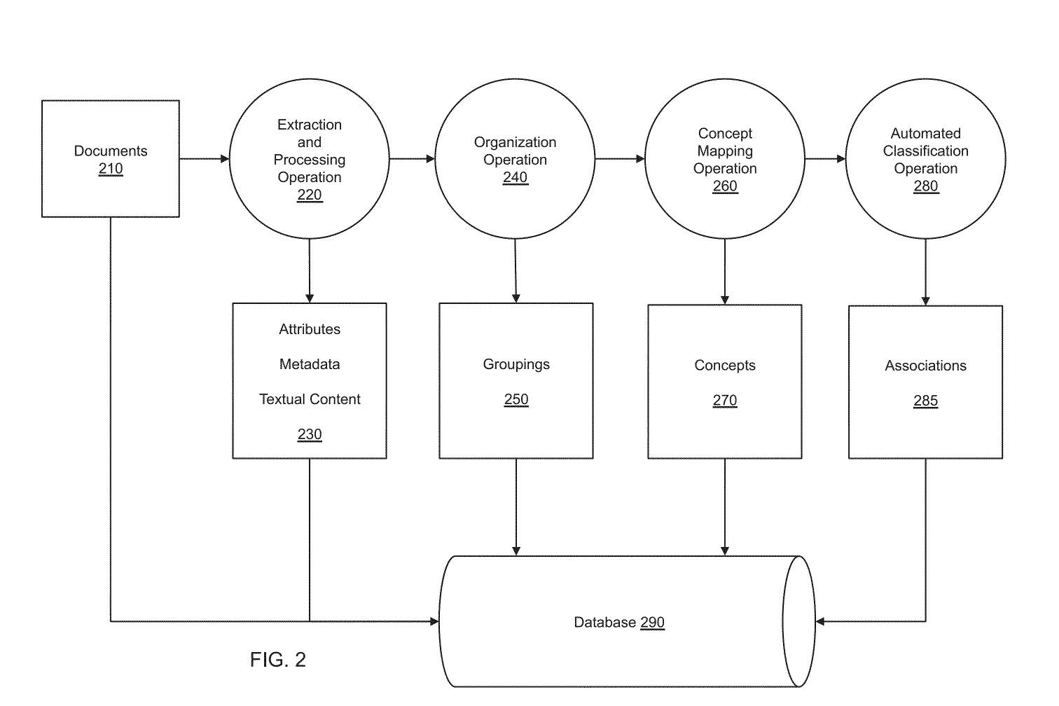

FIG. 2 is a flow diagram depicting an exemplary embodiment of the loading and processing of documents in accordance with one or more aspects of the invention. In an exemplary embodiment of the invention depicted in FIG. 2, unstructured Documents 210 can undergo an Extraction and Processing Operation 220 where various facets—including Attributes, Metadata, and Textual Content 230—can be retrieved from the Documents 210 and saved in a Document Database 290 for subsequent searching and filtering. As mentioned above, Document Database 290 may be implemented as a Structured Query Language (SQL) database or other similar database according to methods known in the art. Document Database 290 may be stored on Database Server 110 or may be distributed across Database Server 110, File Server 120, Analytics Server 130 and/or Web Server 160.

Each of the Attributes, Metadata, and Textual Content 230 can be identified and stored in the Document Database 290 as a separate field or searchable entity within a table. Database 290 can reside on any combination of Database Server 110, File Server 120, Analytics Server 130, and/or Web Server 160.

The extraction component of the Extraction and Processing Operation 220 can extract and retrieve Attributes, Metadata, and Textual Content 230 from the Documents 210 using such techniques as keyword index creation, optical character recognition, metadata extraction, and hidden content identification. Other types of data can be extracted at this step as well, including: document properties, custodian information, source media identification, chain of custody information, file types, family relationships across documents, email properties, email attachments, subdocuments, and other data known by those skilled in the art.

The processing component of the Extraction and Processing Operation 220 can generate additional Attributes, Metadata, and Textual Content 230 associated with the Documents 210 using such additional techniques as optical character recognition, full text indexing and data normalization. The resulting extracted facets, including Attributes, Metadata, and Textual Content 230 can be saved in Database 290. Additionally, system-level attributes, such as successful indexing data, can be saved in the Database 290 after completion of the Extraction and Processing Operation 220.

During the Extraction and Processing Operation 220, additional information—such as search terms, Boolean queries, groups of search terms, and other search-related information—can be input to the database. Such search-related information can form the basis for identifying documents in Database 290 that match the given search terms, Boolean queries, and other search-related information.

Certain components of the Attributes, Metadata, and Textual Content 230 extracted from Documents 210 can be provided to Analytics Server 130 for further processing and storage. Such components may include extracted text. At the Analytics Server 130, these components may be further processed to create indices and other related information that can be used by the Database Server 110 to perform user-initiated searches and filtering operations. Additional data returned to Database Server 110 by Analytics Server 130 may include de-duplication information, email chain information, conceptual search matches. All Attributes, Metadata, and Textual Content 230 extracted from Documents 210 can be saved in the Database 290.

Documents 210 can also undergo an Organization Operation 240 after the Extraction and Processing Operation 220 where the extracted and processed documents can be analyzed for relatedness by comparing the Attributes, Metadata, and Textual Content 230 among the Documents 210 to identify Groupings 250 that can be saved to the Database 290. Embodiments may elect to use Analytics Server 130 to perform these analyses. Examples of Groupings 250 that can be identified include duplicate documents, conversation threads, shared attributes, shared metadata, and shared textual content. Groupings 250 can be assigned unique identifiers and associated with the unique identifiers of individual Documents 210 and saved in the Database 290.

After Organization Operation 240, embodiments may execute a Concept Mapping Operation 260, which may use Analytics Server 130 to perform text analytics operations to find near duplicates and to locate email threads. Organization Operation 240 may also build a conceptual index on Analytics Server 130. The output of Organization Operation 240 is Concepts 270, which collectively represents information extracted from Documents 210 associated with semantic concepts that can be searched. At the end of Organization Operation 240, the Concepts 270 extracted from Documents 210 may be saved in Database 290.

Finally, whenever any Documents 210 are ingested, embodiments of the invention may perform an Automated Classification Operation 280 to apply previously defined searches, filters, queries, and/or classifications to those newly ingested documents. The produced Associations 285 comprises the results of the applied classifications, which may be saved in Database 290. This step ensures that all new documents added to Database 290 are processed in the same manner as any previously loaded documents.

### User Interface

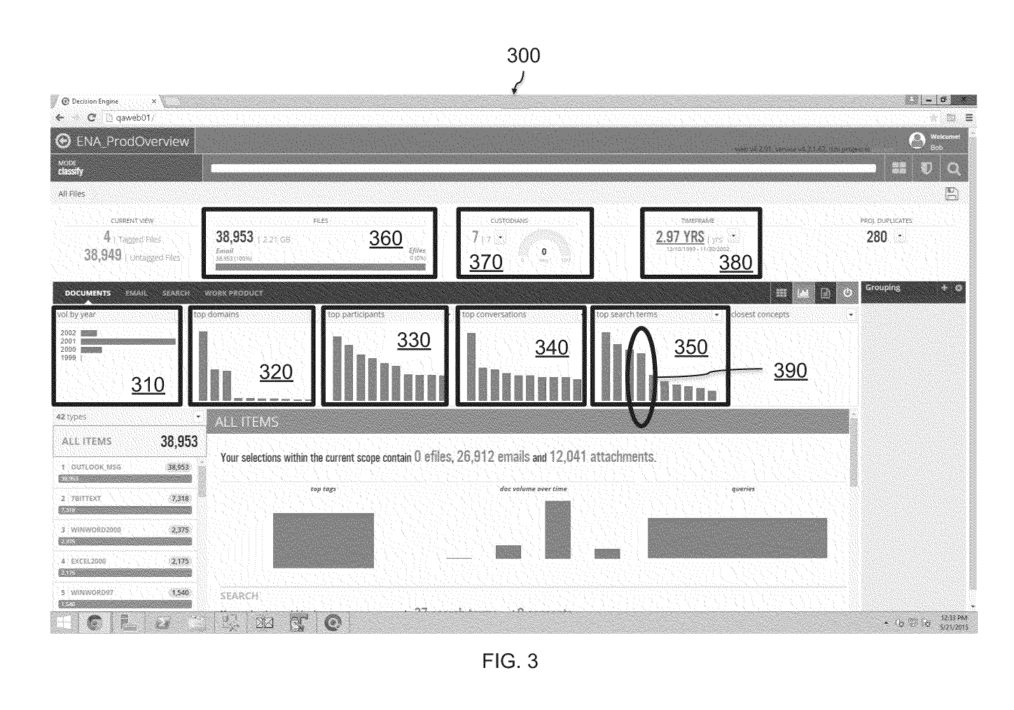

Embodiments of the invention can display a user interface on an Internet browser, where the user interface can facilitate a user's interactions with unstructured Documents 210 that are stored in the Database 290. An exemplary view of a User Interface 300 for at least one embodiment of the invention is illustrated in FIG. 3. Using User Interface 300, embodiments of the present invention can display infographic summaries of the content and statistical information about a current scope of Documents 210 contained in Database 290.

An infographic summary is a visual summary representation of content and statistical data associated with a set of Documents 210 stored in the Database 290. Infographic summaries can render data in a variety of visual representations, including but not limited to: bar graphs, line graphs, scatter plots, pie charts, any other two- or three-dimensional representation, or any combination thereof. Examples of infographic summaries can include depictions of a number of files in the current scope of documents as compared to the number of documents in the entire document collection, a number of custodians assigned to the current scope of documents as compared to the total number of custodians for the document collection, a range of creation dates for documents in the current scope of documents, a number of duplicate documents identified in the current scope of documents, a frequency of documents sorted by creation date, a frequency of documents sorted by file type, a frequency of keywords present in the documents, a frequency of documents sorted by E-mail recipient, or any other depiction of data stored in the database.

A user interface can include multiple infographic summaries, each depicting a different scope of documents. For example, in one embodiment of the invention, a user interface can display infographic summaries depicting data points (and statistical summaries of data points) associated with an entire document collection while simultaneously displaying infographic summaries depicting data points associated with a different scope of documents selected by a user.

The choice of infographic summaries can be set by default or customized by a user through a user interface. By default, a user interface can display a default set of infographic summaries, such as: document size, document count, number of custodians, date span, duplicate documents, frequency of dates, and a selection of the most frequent attributes and textual information.

In one embodiment of the invention, the user interface can be divided into static sections and dynamic sections. In static sections, a chosen set of infographic summaries can remain visible as a user explores the document collection. As filters are applied and the scope of documents is altered, infographic summaries in the static section can remain present but can be updated to continually reflect information associated with current scope of documents. In contrast, as filters are applied and the scope of documents is altered, infographic summaries in the dynamic set can be removed, supplemented, replaced, or updated to reflect the current scope of documents.

In an embodiment of the invention, displayed infographic summaries can be removed, supplemented, replaced, or updated to reflect the current scope of documents automatically or through interactions by a user.

Returning to FIG. 3, embodiments of User Interface 300 can include several different infographic summary presentations, each of which can be configured to visually represent qualitative information about one or more aspects of selected subsets of the Documents 210 stored in the Database 290. Some qualitative information can be obtained from metadata retrieved directly from Database 290 using SQL queries or their equivalent. Other qualitative information can be derived from statistical calculations performed on currently selected subset(s) of Documents 210.

To obtain and/or calculate qualitative information for display by infographic summary presentations, embodiments of the invention can use communications-facilitating software, such as Windows Communication Foundation (“WCF”) to manage the flow of messages and data between User Interface 300 and Database 290 during an Internet browser session. Using WCF capabilities (and other similar frameworks known to those skilled in the art), embodiments of the invention can provide a user with an ability to interact with infographic summaries or components thereof (e.g., the individual bars in a bar graph) in a variety of ways, including: clicking, dragging, and hovering. These user interactions can reveal information about the associated documents. And when the interactions involve user selections, the infographic summaries can create new document filters, as discussed in more detail below, to alter the current scope of documents. For example, embodiments of the invention can display additional information when a user hovers a mouse cursor over a component of an infographic summary; they can also define or apply a filter when a user clicks on a component of an infographic summary.

In FIG. 3, embodiments of the invention can display infographic summaries with selectable components, each of which can depict a facet associated with a given collection of documents. The collection of documents can correspond to the entire document collection or to a particular scope of documents from the document collection, as defined by a set of filters. Item 310 of FIG. 3 illustrates an embodiment of an infographic summary that depicts the number of displayed documents by year of creation as a set of bar graphs. Individual bar components of the infographic summary 310 can be different lengths to visually represent the number of documents having a creation date corresponding to the illustrated years. Each of the components of infographic summary 310 can be individually selectable by a user. When a user selects a specific component of infographic summary 310, embodiments of the invention can create a document filter corresponding to the selected component. For example, if a user clicks on a component corresponding to the year 2002, embodiments of the invention can create a new filter to limit the scope of displayed documents to only those created in the year 2002. In another embodiment, a user can click on multiple components, such as years 2001 and 2002, to define one or more filters that limit the scope of documents to only those having creation dates in 2001 or 2002. In still another embodiment, a user can click on a component corresponding to the year 2002, and define a filter that limits the scope of documents to only those having creation dates in other years (that is, documents not created in 2002).

Item 320 of FIG. 3 is an exemplary embodiment of an infographic summary displaying a frequency of documents by e-mail domain. Individual bar components of the infographic summary 320 can be different lengths, where each length visually represents a relative number of documents associated with a particular e-mail domain. The infographic summary 320 can display components that represent the top 10 (for example) most frequent e-mail domains present in the current scope of documents. Other embodiments of the invention can display different numbers of similar components. For example, an embodiment of the invention could display the 5 least frequent e-mail domains associated with the current scope of documents. Embodiments of the invention can permit a user to click on one or more components of an infographic summary such as item 320 in order to define one or more filters to limit the scope of documents to only those associated with the chosen component(s).

Item 330 of FIG. 3 is an exemplary embodiment of an infographic summary displaying a frequency of documents by participant (e.g., author, sender, recipient, etc.). Individual bar components of the infographic summary 330 can be different lengths, where each length visually represents a relative number of documents associated with a particular participant. The infographic summary 330 can display components that represent the top 10 (for example) participants present in the current scope of documents. Other embodiments of the invention can display different numbers of similar components. For example, an embodiment of the invention could display the 5 least frequent participants associated with the current scope of documents. Embodiments of the invention can permit a user to click on one or more components of an infographic summary such as item 330 in order to define one or more filters to limit the scope of documents to only those associated with the chosen component(s).

Item 340 of FIG. 3 is an exemplary embodiment of an infographic summary displaying a frequency of documents associated with the same conversation. Individual bar components of the infographic summary 340 can be different lengths, where each length visually represents a relative number of documents associated with a particular conversation. The infographic summary 340 can display components that represent the top 10 (for example) most frequent conversations present in the current scope of documents. Other embodiments of the invention can display different numbers of similar components. For example, an embodiment of the invention could display the 5 least frequent conversations associated with the current scope of documents. Embodiments of the invention can permit a user to click on one or more components of an infographic summary such as item 340 in order to define one or more filters to limit the scope of documents to only those associated with the chosen component(s).

Item 350 of FIG. 3 is an exemplary embodiment of an infographic summary displaying a frequency of documents by search term. Individual bar components of the infographic summary 350 can be different lengths, where each length visually represents a relative number of documents associated with a particular predefined search term. The infographic summary 350 can display components that represent the top 10 (for example) most frequent search terms present in the current scope of documents. Other embodiments of the invention can display different numbers of similar components. For example, an embodiment of the invention could display the 5 least frequent search terms associated with the current scope of documents. Embodiments of the invention can permit a user to click on one or more components of an infographic summary such as item 350 in order to define one or more filters to limit the scope of documents to only those associated with the chosen component(s).

Item 360 of FIG. 3 is an exemplary embodiment of an infographic summary displaying the relative number of documents by file type. Individual bar components of the infographic summary 360 can be different lengths to visually represent the number of documents that are e-mails as compared to the number of documents that correspond to other kinds of electronic files in the current scope of documents. For example, infographic summary 360 illustrates that the number of email documents in the database is 38,953, which represents 100% of the documents in Database 290. The textual components of the infographic summary 360 can be altered to represent any combination of file types present in the document collection. Embodiments of the invention allow users to click on one or more components of infographic summary 360 to define one or more filters that can limit the scope of documents to only those associated with the chosen component(s).

Item 370 of FIG. 3 is an exemplary embodiment of an infographic summary displaying the number of custodians for the current scope of documents as compared to the total number of custodians for the entire document collection. The semi-circular bar component of the infographic summary 370 can be different lengths to visually represent the number of custodians for the current scope of documents. In other embodiments of the invention, the bar can be a circle, square, triangle, trapezoid, or any other geometric shape. Additionally, the textual component of the infographic summary 370 can be altered to any alphanumeric combination to represent the custodians for the current scope of documents. A user can click on one or more components of item 370 to define one or more filters that limit the scope of documents to only those associated with the chosen component(s).

Item 380 of FIG. 3 is an exemplary embodiment of an infographic summary displaying the span of time represented by the current scope of documents. The textual components of the infographic summary 380 can be any alphanumeric combination to reflect the amount of time between the document with the earliest creation date and the document with the most recent creation date in the current scope of documents. A user can click on one or more components of item 380 to define one or more filters that limits the scope of documents to only those associated with the chosen component(s).

The visual representations of the infographic summaries 310, 320, 330, 340, 350, 360, 370, and 380 depicted in FIG. 3 only represent some possibilities of many methods that can be used to visually represent data associated with the document collection and/or the current scope of documents. For example, instead of the bar graph depicted in Item 310 some embodiments can display a line graph, a pie chart, a Venn diagram, a scatter plot, or other graphical representations known in the art to be useful for representing subsets.

Embodiments of the invention can allow the user interface 300 to be divided into static sections and dynamic sections. In static sections, a chosen set of infographic summaries can remain visible as a user explores the document collection. Infographic summaries in the static sections of a user interface can reflect information associated with a current scope of documents. In dynamic sections of user interface 300, a set of displayed infographic summaries could change depending on which filter is applied to the document collection.

### User Interface in Action

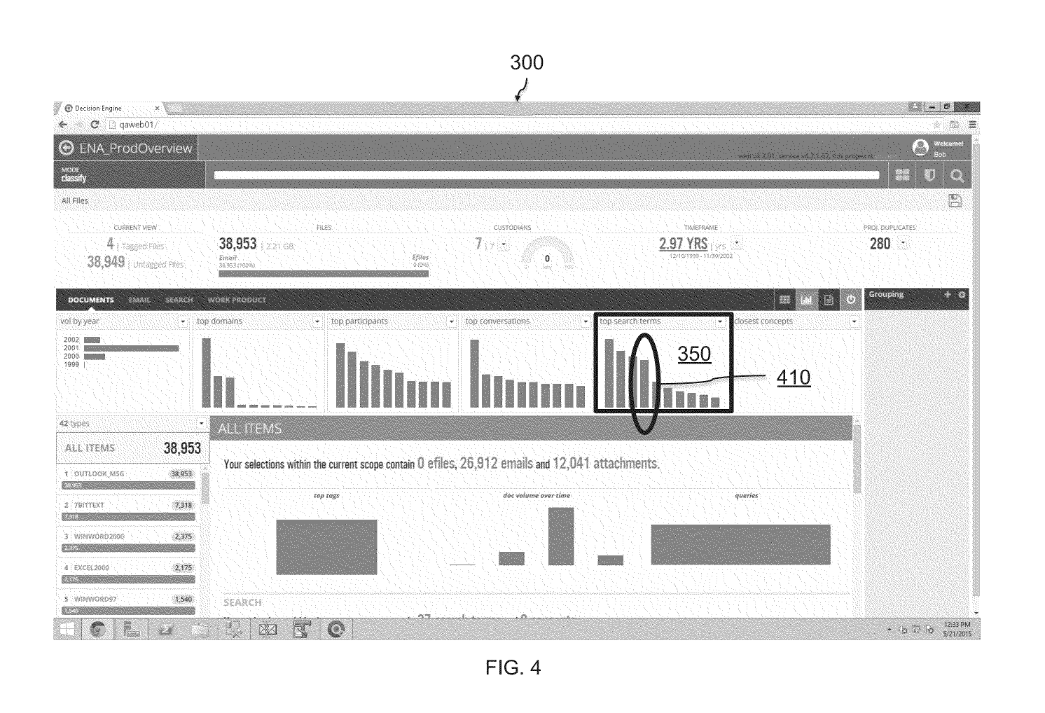

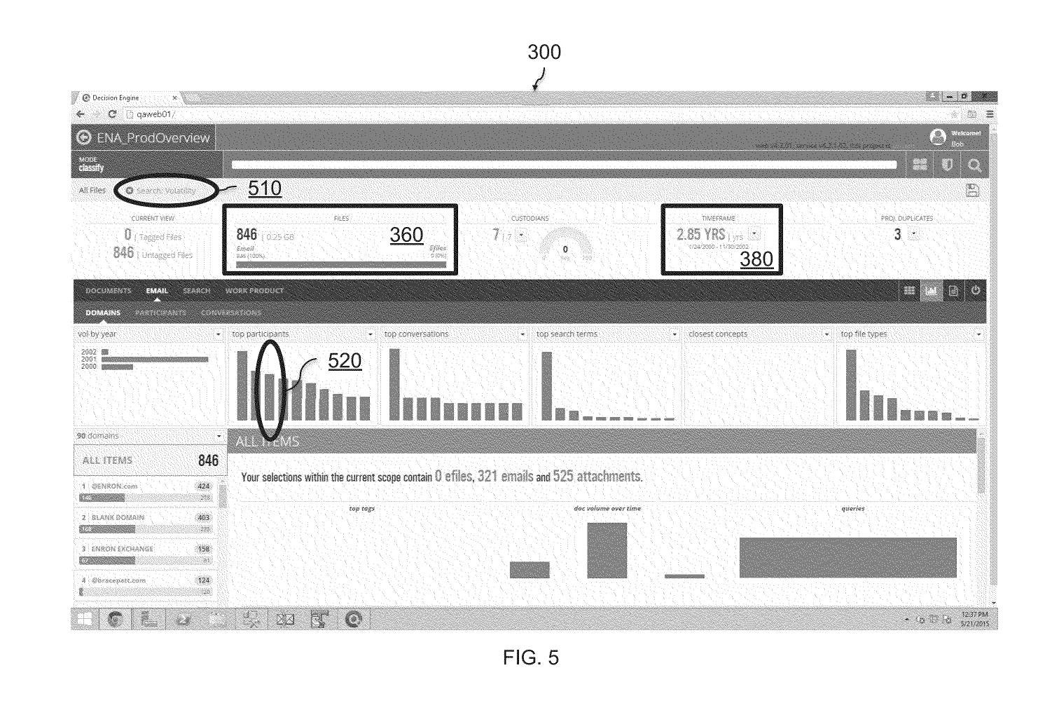

FIG. 4 is an exemplary view of User Interface 300, illustrating the selection of a first infographic component. In FIG. 4, one component of infographic summary 350 has been identified as a search term named “volatility” and is illustrated by a bar chart column identified by Item 410. In embodiments, a user may click on a component of infographic summary 350 associated with a search term. To discover each search term, a user may hover a cursor over each of the displayed columns in infographic summary 350. When embodiments of User Interface 300 detect a hovering action, the embodiments may temporarily show the search term associated with the corresponding column by displaying an overlay of text (not shown) containing the search term. When the search term (or the infographic component 410 associated with that search term) has been selected by the user via a click operation (or by equivalent operations known by those skilled in the art), embodiments of User Interface 300 may then substantially immediately create a new filter based on the selected component (in this case, the search term “volatility”) and generate a display of a new scope of Documents 210 based on that filter, as shown in FIG. 5.

FIG. 5 is an exemplary view of User Interface 300, illustrating the result of a user selecting infographic component 410 (“volatility”) in FIG. 4. Item 510 in FIG. 5 illustrates a filter breadcrumb, indicating that User Interface 300 is displaying the results of a filter, namely that associated with the selection of search term “volatility.” The number of files associated with this filter has now changed. Infographic Summary 360 now shows only 846 files instead of the previous 38,953 (see FIG. 3). So has the time span of documents changes, as illustrated by the change from 2.97 years in FIG. 3 (Item 380) to 2.85 years in FIG. 5 (Item 380). Similarly, many of the other infographic summaries have changed correspondingly as well, thus indicating the ease with which a user may “drill down” to find documents appropriate to a given interest.

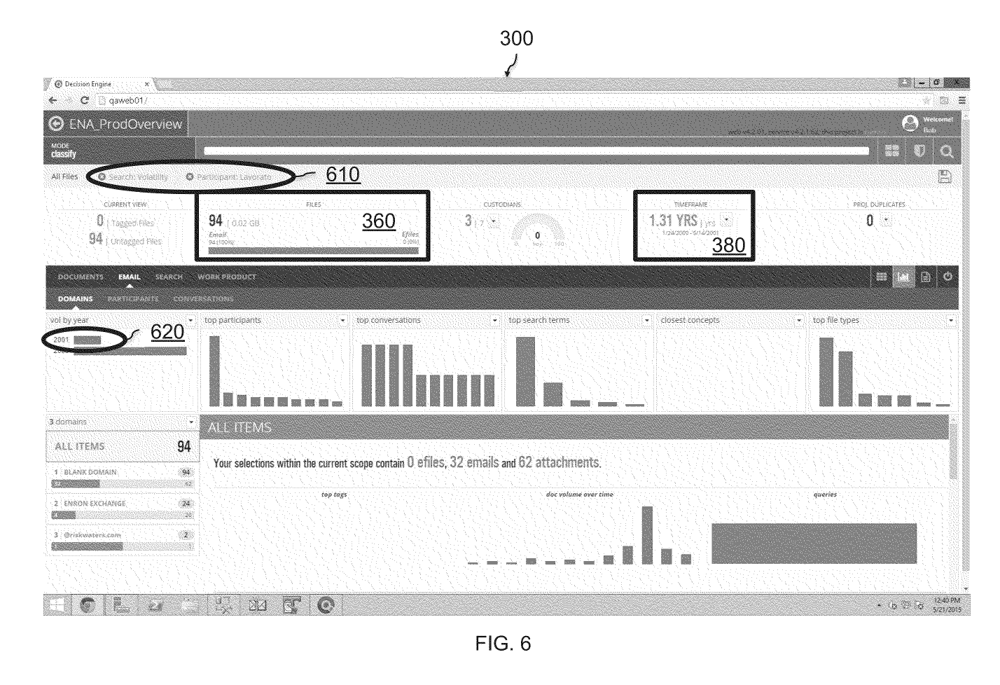

Embodiments may permit any number of filtering steps to be performed. For example, once a user has selected infographic component 410 associated with the search term “volatility,” and User Interface 300 has generated a display of a new scope of documents (see FIG. 5), a user may then (for example) select infographic component 520 associated with a participant named “Lavorato.” In response, embodiments may then create a second filter to further reduce the scope of displayed Documents 210, as shown in FIG. 6.

FIG. 6 is an exemplary view of User Interface 300, illustrating the result of a user selecting infographic component 520 (“Lavorato”) in FIG. 5. Item 610 in FIG. 6 illustrates a new filter breadcrumb (an updated version of Item 510), indicating that User Interface 300 is displaying the results of two filters, namely the filter associated with the selection of search term “volatility,” and the filter associated with the selection of participant named “Lavorato.” Again, the number of files associated with the filters has changed. Infographic Summary 360 now shows only 94 files instead of the previous 846 (see FIG. 5). And the time span of documents has also changed from 2.85 years in FIG. 5 (Item 380) to 1.31 years in FIG. 6 (Item 380). Similarly, many of the other infographic summaries have also changed correspondingly, thus indicating the ease with which a user may continue to “drill down” to find documents appropriate to a given interest.

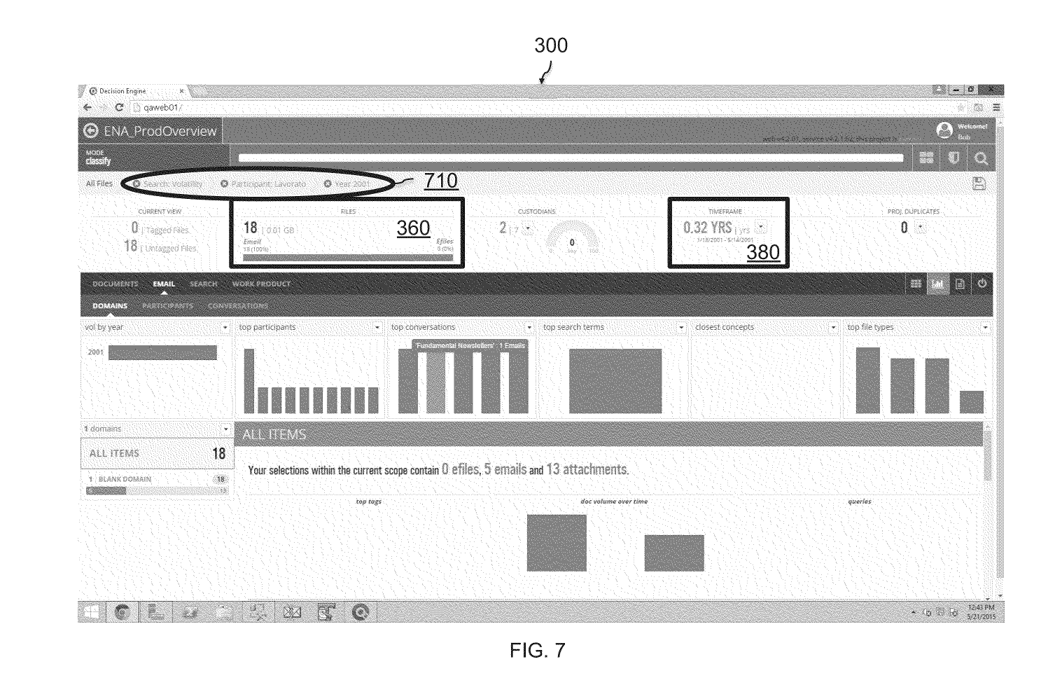

In FIG. 6, a user may (for example) select infographic component 620 associated with the year 2001. In response, embodiments may then create a third filter to further reduce the scope of displayed Documents 210, as shown in FIG. 7.

FIG. 7 is an exemplary view of User Interface 300, illustrating the result of a user selecting infographic component 620 (“year 2001”) in FIG. 6. Item 710 in FIG. 7 illustrates a new filter breadcrumb (an updated version of Item 610), indicating that User Interface 300 is displaying the results of three filters, namely the filter associated with the selection of search term “volatility,” the filter associated with the selection of participant named “Lavorato,” and the filter associated with the selection of “year 2001.” Again, the number of files associated with the filters has changed. Infographic Summary 360 now shows only 18 files instead of the previous 94 (see FIG. 6). And the time span of documents has also changed from 1.31 years in FIG. 6 (Item 380) to 0.32 years in FIG. 7 (Item 380). Similarly, many of the other infographic summaries have also changed correspondingly, thus continuing to indicate the ease with which a user may continue to “drill down” to find documents appropriate to a given interest. At this point, or at any point in an exploration of documents using User Interface 300, a user may elect to review each of the documents in the current scope of documents.

### Filter Breadcrumb Trail

The filters listed in the breadcrumb trail 710 represent the filters currently being used to define the scope of documents. These filters can be ordered hierarchically, sequentially as applied, alphabetically, or in any other organization. A user can interact with a filter listed in the breadcrumb trail 710 to remove other filters following it. For example, if filters are displayed sequentially in order of application, a user can click on a filter to remove all subsequently applied filters, or alternatively, if filters are displayed hierarchically, a user can click on a filter to remove all sub-filters underneath. Removal of filters can redefine the current scope of documents and update statistical calculations and associated infographic summaries.

In other embodiments of the invention, a user can interact with a filter to remove only that filter, and can, thereby, redefine the current scope of documents and update statistical calculations and associated infographic summaries.

In still other embodiments of the invention, a user can interact with a filter in the breadcrumb trail to change its logical operation. For example, a user can click a filter to change it from a logical “AND” operation to a logical “OR operation, or vice-versa. A change in logical operation of a filter can redefine the current scope of documents and update statistical calculations and associated infographic summaries.

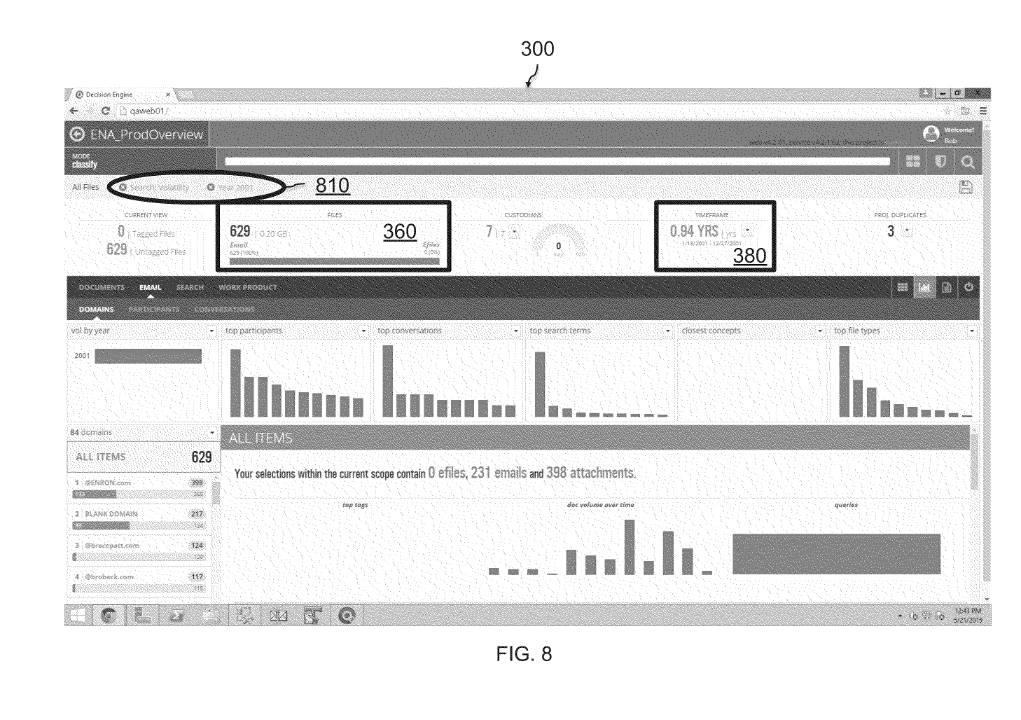

Returning to FIG. 7, embodiments may allow a user to edit components of a filter breadcrumb trail (such as filter breadcrumb trail 710) directly. For example, a user may click on the “Lavorato” component of filter breadcrumb trail 710. In response, User Interface 300 may provide a pop-up list of options to a user. One option can be “delete.” Other options known to those skilled in the art for manipulating elements of a list can be provided as well. If a user elects to delete a component of a filter breadcrumb (for example, deleting “Lavorato”), embodiments may then, in response, recalculate the scope of displayed Documents 210, as shown in FIG. 8.

FIG. 8 is an exemplary view of User Interface 300, illustrating the result of a user deletion of a component of filter breadcrumb trail 710. Item 810 in FIG. 8 illustrates the edited filter breadcrumb (an updated version of Item 710), indicating that User Interface 300 is displaying the results of two filters, namely the filter associated with the selection of search term “volatility,” and the filter associated with the selection of “year 2001.” Again, the number of files associated with the filters has changed. Infographic Summary 360 now shows 629 files instead of the previous 18 (see FIG. 7). And the time span of documents has also changed from 0.32 years in FIG. 7 (Item 380) to 0.94 years in FIG. 8 (Item 380). Similarly, many of the other infographic summaries have also changed correspondingly, thus continuing to indicate the ease with which a user may modify filters to explore documents appropriate to a given interest. Again, at this point, or at any point in an exploration of documents using User Interface 300, a user may elect to review each of the documents in the current scope of documents.

### Filter Implementation

Embodiments of the invention can allow a user to narrow or broaden a set of displayed documents by defining filters. Filters can be defined in a variety of ways, such as interacting with one or more components of one or more infographic summaries, performing keyword searches, choosing labels, choosing concepts, choosing associations, or any combination thereof.

A filter or set of filters can comprise a database search query and can be assigned a unique identifier. In one embodiment of the invention, documents matching a particular database search query can be marked as “included” by associating the unique identifier of the filter with the documents in the Database 290. Thus, when a user applies a filter in an embodiment of the invention that employs an “included” marking system, documents associated with the unique identifier of the filter can be retrieved. In other embodiments of the invention, documents that do not match a database search query can be marked as “excluded” by associating the unique identifier of the filter with matching documents found in the database. Thus, when a user applies a filter in an embodiment of the invention employing an “excluded” feature, documents lacking an association with the unique identifier of the filter can be retrieved. Another embodiment of the invention can simultaneously employ “included” and “excluded” marking systems for the unique identifiers of filters, such that the unique identifiers of some filters can act as “included” marks and unique identifiers of other filters can act as “excluded” marks. Another embodiment of the invention can contextually use a filter as either an “excluded” or an “included” mark depending on when and how the filter is applied.

A user can combine filters via a logical “AND” operator that requires documents to possess both chosen filters, or via a logical “OR” operator that requires documents to have either one or both of the two chosen filters. A user can combine multiple filters using the “AND” and “OR” logical operators to define a current scope of documents from the document collection that satisfies the criteria imposed by the applied filters. As a user adds or removes filters and logical operators, the current scope of documents is continually refined.

In an embodiment, when a user first begins to interact with unfiltered documents stored in a Database 290, the user will typically be presented with a display of infographic summaries corresponding to all of the documents or files in the database, such as shown in FIG. 3. This “All Files” view of the Database 290 is essentially a query with no filters. That is, all subsequent filters will build on this initial view of all documents.

According to embodiments, the first filter can be called a scope filter. The scope filter serves to identify the initial scope of subsequent queries within the “all files” population of documents in Database 290. When the initial scope filter is created by a user and added to the (initially empty) list of filters, embodiments can perform the following steps:

(1) A record for a SQL query (or its equivalent) can be created within the Database 290.

(2) A record for the initial scope filter can be made within the Database 290 and then associated with the SQL query.

(3) A table can be dynamically generated utilizing a unique identifier for the SQL query. This table is referred to as the “Query Table.” Unique identifiers for all documents within the current scope of documents can be added to the table. Thus, initially, all documents in the Database 290 will be identified in the Query Table. From this point forward, the documents in the Query Table will then drive the content of the displayed infographic summaries.

As users create and add document filters, documents that match each filter will be marked within the Query Table with a unique identifier associated with the filter. All non-filtered documents within the Query Table will continue to be used in order to scope all visual metadata, thereby restricting the visual infographic summaries to correspond to the reduced set of documents within the scope of the current query.

### Iterative Filtering and Infographic Rendering

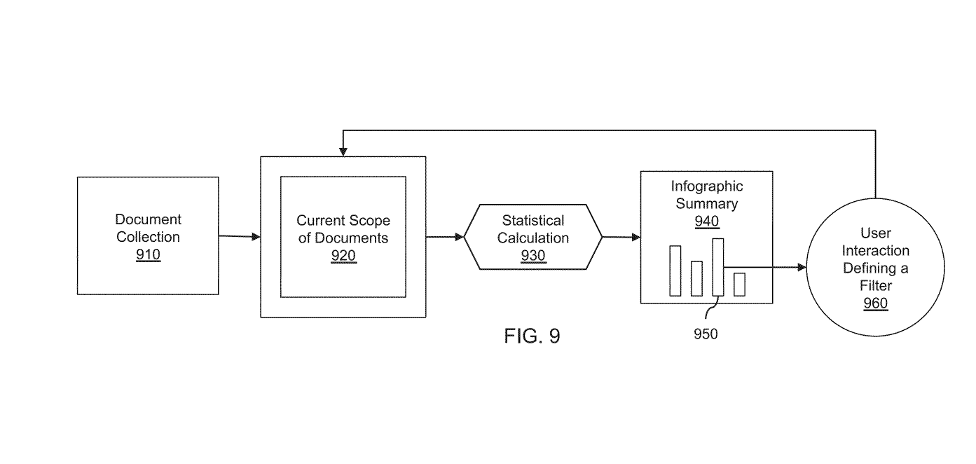

FIG. 9 is a flow diagram depicting an exemplary embodiment of a method for filtering a document collection in an iterative fashion in accordance with one or more aspects of the invention. In FIG. 9, initially the a given Document Collection 910 can be defined as the Current Scope of Documents 920. Statistical Calculations 930 can be performed on the Current Scope of Documents 920 to generate Infographic Summaries 940 for display on User Interface 300 (for example, Infographic Summaries 310, 320, 330, 340, 350, 360, 370, and 380 of FIG. 3). Infographic Summaries 940 can have one or more Visual Components 950 that, when selected by a user to define a filter at step 960, can redefine the Current Scope of Documents 920. Initially, a first User Interaction Defining a Filter 960 may narrow the Current Scope of Documents 920, but subsequent User Interactions Defining a Filter 960 can also broaden or narrow the Current Scope of Documents 920 depending on the logical operation involved. Regardless of whether the Current Scope of Documents 920 is redefined through narrowing or broadening, Statistical Calculations 930 can be performed on the redefined Current Scope of Documents 920 and Infographic Summaries 940 can be updated on User Interface 300 to reflect information pertaining to the redefined Current Scope of Documents 920.

### Filtering with Dynamic SQL

According to embodiments, filters may be implemented by dynamically generating the SQL statements associated with isolating the documents associated with filter criteria. In order to apply these filters to documents loaded into the database in an ongoing manner, the dynamically generated SQL statements themselves must be persisted. To maintain the responsiveness of a fixed database schema while allowing for innumerable combinations of filters, tables for each saved query may be dynamically created within the underlying database and populated with the documents responsive to the associated filters. This approach can allow filters to be scalable across exceptionally large document populations.

### Labels

Embodiments of the invention can allow a user to create and associate labels with documents in a database. Labels can be user-defined and/or chosen from a predetermined list, such as “sensitive,” “important,” or “not relevant.” A user can associate any number of labels with a document and associate labels with multiple documents simultaneously. A label associated with a unique identifier can be used as a filter in substantially the same way as a component of an infographic summary or a keyword.

### User Associations

Embodiments of the invention can associate user actions with documents in the database. Each user can be associated with a unique identifier, such that if a user creates a filter or label, for example, the unique identifier for that user is associated with the unique identifier for the filter or label.

### Automated Classification

As mentioned above, some embodiments can provide a user interface that allows a user to save a set of breadcrumb steps as a saved filter. The saved filter can then be applied as a classification rule for future documents that are added to the existing database. As new documents are ingested into the system and structure is applied (for example when a new Document Collection 910 is added to a Database 290, see FIG. 9), the existing filters can be refreshed to determine whether or not the newly added documents are responsive. The newly added documents can be automatically added to saved queries where applicable so that decisions made on data can be applied to all new documents introduced to the system.

### Viewing Individual Documents

Embodiments of the invention can also allow a user to view individual documents from the current scope being analyzed or even from the entire document collection. At any time during document exploration, a user can retrieve a list of documents associated with a selected scope of analysis from the database. A user can select a document this list to view either the original document or a copy of the document stored in the database.

### Computing Device

As may be appreciated by one skilled in the art, the invention may be embodied as a method, system, computer program product, or any combination thereof. Accordingly, the invention may take the form of a software embodiment (including firmware, resident software, micro-code, etc.) or an embodiment combining software and hardware components that may generally be referred to herein as a system. Furthermore, embodiments of the invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet, an intranet, or a wireless network. Note that the computer-readable medium could even be paper or another suitable medium upon which the program is printed, as the program can be electronically captured, for instance, by optical scanning of the paper or other medium, then compiled, interpreted, or otherwise processed in a suitable manner, if necessary, and then stored in a computer memory.

Computer program code for carrying out operations of embodiments of the invention may be written in an object oriented, procedural, scripted or unscripted programming language such as Java, JavaScript, Perl, PHP, ASP, ASP.NET, Visual J++, J#, C, C++, C#, Visual Basic, VB.Net, VBScript, SQL, or the like.

The computers utilized in the present invention may run a variety of operating systems, such as, Microsoft Windows, Apple Mac OS X, Unix, Linux, GNU, BSD, FreeBSD, Sun Solaris, Novell Netware, OS/2, TPF, eCS (eComStation), VMS, Digital VMS, OpenVMS, AIX, z/OS, HP-UX, OS-400, etc. The computers utilized in the present invention can be based on a variety of hardware platforms, such as, x86, x64, Intel, IA64, AMD, Sun Sparc, IBM, HP, etc.

The databases used on electronic storage devices in the present invention may include: Clarion, DBase, EnterpriseDB, ExtremeDB, Filemaker Pro, Firebird, FrontBase, Helix, SQLDB, IBM DB2, Informix, Ingres, InterBase, Microsoft Access, Microsoft SQL Server, Microsoft Visual FoxPro, MSQL, MYSQL, OpenBase, OpenOffice.Org Base, Oracle, Panorama, Pervasive, Postgresql, SQLbase, SQLite, SyBase, Teradata, Unisys, and many others.

Embodiments of the invention are described below with reference to flowchart illustrations and/or block diagrams of methods, apparatuses (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

Computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

Computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

In an exemplary embodiment of the invention, a computing device can be configured as a server device to store, modify, and provide access to unstructured data.

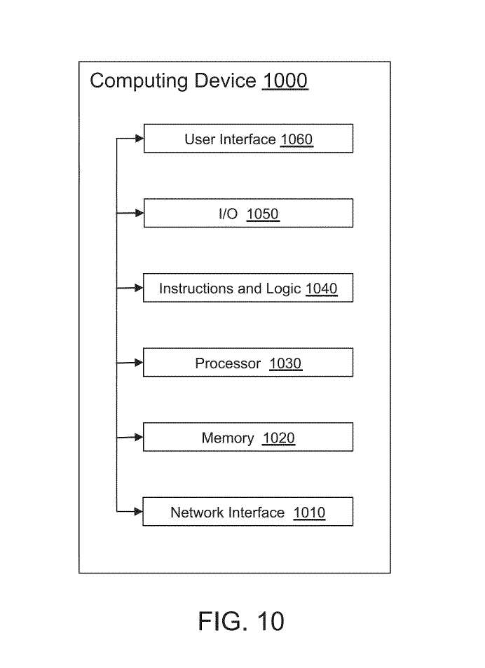

FIG. 10 is a block diagram of an exemplary embodiment of a Computing Device 1000 in accordance with the present invention. Computing Device 1000 can comprise any of numerous components, such as for example, one or more Network Interfaces 1010, one or more Memories 1020, one or more Processors 1030 including program Instructions and Logic 1040, one or more Input/Output (I/O) Devices 1050, and one or more User Interfaces 1060 that may be coupled to the I/O Device(s) 1050, etc.

Computing Device 1000 may comprise any device known in the art that is capable of processing data and/or information, such as any general purpose and/or special purpose computer, including as a personal computer, workstation, server, minicomputer, mainframe, supercomputer, computer terminal, laptop, tablet computer (such as an iPad), mobile terminal, smart phone (such as an iPhone, Android device, or BlackBerry), or the like, etc. In general, any device on which a finite state machine resides that is capable of implementing at least a portion of the methods, structures, and/or interfaces described herein may comprise Computing Device 1000.

Memory 1020 can be any type of apparatus known in the art that is capable of storing analog or digital information, such as instructions and/or data. Examples include a non-volatile memory, volatile memory, Random Access Memory (RAM), Read Only Memory (ROM), flash memory, magnetic media, hard disk, floppy disk, magnetic tape, optical media, optical disk, compact disk (CD), digital versatile disk or digital video disk (DVD), and/or RAID array, etc. The memory device can be coupled to a processor and/or can store instructions adapted to be executed by processor, such as according to an embodiment disclosed herein.

Input/Output (I/O) Device 1050 may comprise any sensory-oriented input and/or output device known in the art, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, vibrator, tactile simulator, and/or tactile pad, optionally including a communications port for communication with other components in Computing Device 1000.

Instructions and Logic 1040 may comprise directions adapted to cause a machine, such as Computing Device 1000, to perform one or more particular activities, operations, or functions. The directions, which can sometimes comprise an entity called a “kernel”, “operating system”, “program”, “application”, “utility”, “subroutine”, “script”, “macro”, “file”, “project”, “module”, “library”, “class”, “object”, or “Application Programming Interface,” etc., can be embodied as machine code, source code, object code, compiled code, assembled code, interpretable code, and/or executable code, etc., in hardware, firmware, and/or software. Instructions and Logic 1040 may reside in Processor 1030 and/or Memory 1020.

Network Interface 1010 may comprise any device, system, or subsystem capable of coupling an information device to a network. For example, Network Interface 1010 can comprise a telephone, cellular phone, cellular modem, telephone data modem, fax modem, wireless transceiver, Ethernet circuit, cable modem, digital subscriber line interface, bridge, hub, router, or other similar device.

Processor 1030 may comprise a device and/or set of machine-readable instructions for performing one or more predetermined tasks. A processor can comprise any one or a combination of hardware, firmware, and/or software. A processor can utilize mechanical, pneumatic, hydraulic, electrical, magnetic, optical, informational, chemical, and/or biological principles, signals, and/or inputs to perform the task(s). In certain embodiments, a processor can act upon information by manipulating, analyzing, modifying, converting, transmitting the information for use by an executable procedure and/or an information device, and/or routing the information to an output device. A processor can function as a central processing unit, local controller, remote controller, parallel controller, and/or distributed controller, etc. Unless stated otherwise, the processor can comprise a general-purpose device, such as a microcontroller and/or a microprocessor, such the Pentium IV series of microprocessors manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein.

User Interface 1060 may comprise any device and/or means for rendering information to a user and/or requesting information from the user. User Interface 1060 may include, for example, at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, auto-sizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.

The foregoing disclosure has been set forth merely to illustrate the invention and is not intended to be limiting. It will be appreciated that modifications, variations and additional embodiments are covered by the above teachings and within the purview of the appended claims without departing from the spirit and intended scope of the invention. Other logic may also be provided as part of the exemplary embodiments but are left out here so as not to obfuscate the invention. Since modifications of the disclosed embodiments incorporating the spirit and substance of the invention may occur to persons skilled in the art, the invention should be construed to include everything within the scope of the appended claims and equivalents thereof.

1. A computerized method for filtering unstructured documents, comprising:
loading unstructured documents into a database residing on a server;
identifying a first selection of the unstructured documents, the first selection initially corresponding to all of the unstructured documents;
calculating a plurality of first statistical summaries about the first selection of unstructured documents;
issuing computer instructions to display, over a network via an Internet browser session, an interactive infographic representation of each of the plurality of first statistical summaries, where each of the interactive infographic representations includes at least one individually selectable component;
receiving an indication that a user has selected one of the individually selectable components;
creating a filter based on the selected component, said filter comprising a database query;
executing the filter on the first selection of unstructured documents;
obtaining a second selection of unstructured documents from the database based on results of the executed filter;
calculating a plurality of second statistical summaries about the second selection of unstructured documents; and
issuing computer instructions to display, via the Internet browser session, an interactive infographic representation of each of the plurality of second statistical summaries.

2. The method of claim 1, wherein at least one of the interactive infographic representations comprises at least one of: a bar graph, a line graph, a pie chart, a Venn diagram, or a scatter plot.

3. The method of claim 1, wherein the filter is a SQL query.

4. The method of claim 1, wherein the filter includes a keyword provided by the user.

5. The method of claim 1, wherein the filter is saved in the database.

6. The method of claim 5, wherein the filter is saved with a selectable label.

7. The method of claim 5, further comprising: executing the saved filter on a collection of new unstructured documents, as they are loaded into the database.

8. The method of claim 1, wherein each of the individually selectable components corresponds to a facet.

9. The method of claim 8, wherein each facet corresponds to a metadata value.

10. The method of claim 1, wherein the second selection of unstructured documents is a subset of the first selection of unstructured documents.

11. The method of claim 10, wherein each document in the second selection of unstructured documents matches the filter.

12. The method of claim 1, wherein each individually selectable component represents at least a portion of its corresponding first statistical summary

13. The method of claim 1, wherein the first statistical summaries include a count of documents associated with a participant.

14. The method of claim 1, wherein the first statistical summaries include a count of documents associated with each conversation.

15. The method of claim 1, wherein the first statistical summaries include a count of documents by time frame.

16. The method of claim 1, wherein the calculation of the plurality of second statistical summaries involves marking documents in a dynamically created SQL table that match the filter.

17. A computerized method for filtering unstructured documents, comprising:
loading unstructured documents into a database residing on a server;
calculating a plurality of statistical summaries about the unstructured documents;
issuing computer instructions to display, over a network via an Internet browser session, an interactive infographic representation of each of the plurality of statistical summaries, where each of the interactive infographic representations includes at least one individually selectable component;
receiving an indication that a user has selected one of the individually selectable components;
creating a filter based on the selected component, said filter comprising a database query;
executing the filter on the unstructured documents;
obtaining a selection of unstructured documents from the database based on results of the executed filter;
updating the statistical summaries based on the selection of unstructured documents; and
issuing computer instructions to update, via the Internet browser session, the interactive infographic representations based on the updated statistical summaries.
